(19) United States
(12) Patent Application Publication
(10) Pub. No.: US 2004/0048291 A1
(43) Pub. Date: Mar. 11, 2004

(54) Method and apparatus for continuous processing of organic material

(75) Inventor: Palle Hobolth, Hillerod (DK)

Correspondence Address: DARBY & DARBY P.C., Post Office Box 5257, New York, NY, 10150-5257, US

(73) Assignee: HOBOLTH INSTRUMENTS ApS, Hillerod (DK)

(21) Appl. No.: 10/465,834

(22) Filed: Jun. 13, 2003

Related U.S. Application Data
(63) Continuation of application No. PCT/DK01/00826, filed on Dec. 13, 2001.

(30) Foreign Application Priority Data
Dec. 15, 2000 (DK) PA 2000 01887

(51) Int. Cl. C12Q 1/68; G01N 33/558

(52) U.S. Cl. 435/6; 436/514

(57) ABSTRACT

The present invention is directed to methods and corresponding apparatuses for the continuous processing of organic materials. More specifically, the invention provides methods and apparatuses in which processing steps are performed using serially connected processing means, this allowing both for efficient processing as well as provides a high degree of safety against contamination from the exterior.

### FIELD OF THE INVENTION

The present invention is directed to methods and corresponding apparatuses for the continuous processing of organic materials. More specifically, the invention relates to methods and apparatuses in which processing steps are performed using serially connected processing means, this allowing both for efficient processing as well as provides a high degree of safety against contamination from the exterior.

### BACKGROUND OF THE INVENTION

When processing biological samples, typically a number of processing steps have to be performed. The processing steps may relate to recovery, synthesis or identification processes. As an example, the background for the recovery of synthesized organic molecules will be used as an illustrative example.

Synthesis of repetitive organic molecules, including biopolymers, oligonucleotides, oligoribonucleotides, oligosaccharides, peptides and combinations thereof is conventionally performed by having precursor molecules and/or reactants adhered to a suitable matrix or support material. For example, the synthesis of oligo- and polynucleotides involves stepwise assembling of individual mononucleotide units by chemical synthesis according to a defined sequence (see M. J. Gait, Oligonucleotide synthesis, a practical approach, IRL Press, 1984). Repetitive sequences of detritylation, wash, activation, coupling, wash, capping, wash, oxidation and wash are used to introduce each nucleotide. In order to minimize undesired side reactions during the synthesis, two different types of protecting group are used, permanent protection of the primary amine groups on all heterocyclic bases and the hydroxyl groups on the phosphorous of all nucleotides, and temporary protection on the 5-hydroxy group of the incoming nucleotide.

The liberation of oligonucleotides from the protection groups and the support, i.e. deprotection and cleavage, are usually performed by base treatment, e.g. by the use of a 25%-35% ammonia solution. The temporary protection groups, such as 4,4′dimethoxytrityl- (DMT-), are removed during the detritylation step. The DMT group on the last incoming nucleotide is often retained to assist in the later purification procedure. The DMT group on the oligonucleotide can easily be removed by acid treatment.

After synthesis the molecules have to be recovered by steps including cleavage of the molecules from the synthesis matrix, deprotection, purification and transfer of the molecules to a desired medium, e.g. a buffer solution. The latter step may also have to be performed between one or more of the mentioned steps.

Whereas synthesis of nucleotides and peptides typically are performed automatically at a single location using a matrix, the different reactants being supplied in a specified manner and under specified conditions, the above-described process steps necessary for the recovery of the desired molecules has traditionally been performed manually in a step-wise fashion process-for-process, or recently, by automated set-ups in which robots are used to perform the different steps.

An example of this approach is known from WO 93/20130 disclosing an apparatus for processing biopolymer-containing columns, i.e. recovery of organic molecules contained in a matrix. In summary, this application discloses an apparatus comprising solvent supplying means having an outlet, column means for holding a matrix sample and having an inlet and an outlet, the inlet being in fluid communication with the outlet of the fluid supplying means, this representing the basic set-up for the known apparatus. In preferred embodiment the outlets of the means for holding a matrix sample may be connected to (i) liquid receiving means having an inlet and an outlet, or (ii) process means having an inlet. More specifically, the disclosed liquid receiving means (i) are described as either a syringe which can be used to re-deliver the liquid to the column, or tubing for transporting liquid to a waste receptacle or for further non-described processing steps. As appears, no processing in the form of interaction with organic molecules takes place in the liquid receiving means, but merely “transport”. The disclosed process means (ii) is in the form of a heating block wherein containers having an inlet are inserted, the inlet also serving as a subsequent outlet after the heating process. As appears, no means is provided for transporting the substance out of the containers after heat treatment.

The same step-wise approach is used also in other aspects of handling and processing biological samples, for example in the synthesis of nucleotides or in the identification of sample components.

### SUMMARY OF THE INVENTION

Having regard to the above discussion of the prior art, a primary object of the present invention is to provide methods and apparatuses in which organic material can be processed in an efficient and cost-effective manner, yet minimizing the risk of contamination.

More specifically, the present invention is based on the realization that the above-identified objects can be achieved by serially connecting a number of process means in fluid communication with each other, the transport of the biological material being performed by controlling the flow of fluid through the serially connected process means, allowing a desired process to be fully or partly performed in a linear, continuous fashion.

By this arrangement it is possible to control the flow of sample material through a number of process means, this allowing for a fully automated set-up and as the system is essentially closed, the risk for contamination is significantly reduced.

In contrast, the apparatus and method disclosed in WO 93/20130 is primarily concerned with the single step of treating a matrix contained in a column. For further processing, the resulting biopolymer is either transported to further non-specified process means by syringes or tubing, or the biopolymer is transferred to a container for subsequent heat treatment, the container representing a “dead end” from which the biopolymer has to removed either manually or by insertion into a different non-described process means.

In a first aspect of the invention a method for processing organic material is provided, comprising the steps of: providing a fluid supplying means, a receiving means having a conduit adapted for receiving a sample of organic material, at least first and second process means each having a conduit associated with a process means for processing a sample of the organic material, providing serial fluid communication between the respective conduits, thereby establishing at least one conduit through which fluids can be supplied from the fluid supplying means through the receiving means and the at least two process means, wherein organic material is placed in the receiving means, and at least one fluid is conducted through the serially connected conduits.

In a preferred embodiment the method is adapted for recovery of an organic compound contained in a matrix and arranged in the receiving means, whereby at least one of the process means is taken from the group comprising heat exchange means comprising heating means, purification means comprising means for reversibly binding an organic compound in a stationary phase, and solvent exchange means.

In a further preferred embodiment the method is adapted for synthesis of an organic compound, e.g. by PCR, the compound being initially placed in the receiving means, wherein one of the process means comprises heating means as well as flow control means acting on the in- and outlets thereof.

Correspondingly, a first apparatus for processing organic material is provided, comprising fluid supplying means, receiving means having a conduit adapted for receiving a sample of organic material, at least first and second process means each having a conduit associated with a process means for processing a sample of the organic material, the means being arranged providing serial fluid communication between the respective conduits, thereby establishing at least one conduit through which fluids can be supplied from the fluid supplying means through the receiving means and the at least two process means. The fluid supplying means is preferably adapted for sequentially supplying a plurality of fluids or mixtures thereof.

In a preferred embodiment the apparatus is adapted for recovery of an organic compound contained in a matrix being placed in the receiving means, whereby at least one of the process means is taken from the group comprising heat exchange means comprising heating means, purification means comprising means for reversibly binding an organic compound in a stationary phase, and solvent exchange means.

In a further preferred embodiment the method is adapted for synthesis of an organic compound being initially placed in the receiving means, whereby one of the process means is adapted for supplying heat and comprises flow control means acting on the in- and outlets thereof.

In a second aspect a method for processing organic material is provided, comprising the steps of: providing a fluid supplying means, a receiving means having a conduit adapted for receiving a sample of organic material, at least one process means comprising a conduit having an inlet and an outlet, the conduit having associated therewith a process means for processing a sample of organic material, wherein at least one of the receiving or process means comprises heating means adapted for supplying heat to the conduit and comprises flow control means acting on the in- and outlets thereof, providing serial fluid communication between the respective conduits, thereby establishing at least one conduit through which fluids can be supplied from the fluid supplying means through the receiving means and the at least one process means, wherein organic material is placed in the receiving means, and at least one fluid is conducted through the serially connected conduits.

Heat treatment during, for example, deprotection or PCR synthesis has hitherto been performed in separate vessels, however, by controlling the flow from the reaction chamber, it is possible to include heat treatment in a serial set-up, the flow control means preventing the fluids from escaping as it expands. The flow control means may be in the form of traditional valves, pinch valves, or cooling means, the latter blocking the flow by freezing an amount of liquid.

In a preferred embodiment for the method, the heat supplying means is provided in combination with the receiving means, the process means being taken from the group comprising purification means comprising means for reversibly binding an organic compound in a stationary phase, and solvent exchange means.

Correspondingly, a second apparatus for processing organic material is provided, comprising fluid supplying means, receiving means having a conduit adapted for receiving a sample of organic material, at least one process means comprising a conduit having an inlet and an outlet, the conduit having associated therewith a process means for processing a sample of organic material, wherein at least one of the receiving or process means comprises heating means adapted for supplying heat to the conduit and comprises flow control means acting on the in- and outlets thereof, the means being arranged providing serial fluid communication between the respective conduits, thereby establishing at least one conduit through which fluids can be supplied from the fluid supplying means through the receiving means and the at least two process means. The fluid supplying means is preferably adapted for sequentially supplying a plurality of fluids or mixtures thereof.

In a preferred embodiment of the apparatus, the heat supplying means is provided in combination with the receiving means, the process means being taken from the group comprising purification means, preferably comprising means for reversibly binding an organic compound in a stationary phase, and solvent exchange means.

In a further aspect an apparatus is provided comprising a conduit having an inlet and an outlet, the conduit having associated therewith heating means adapted for supplying heat to the conduit, as well as actuatable flow control means acting on the in- and outlets thereof.

In a basic set-up, the different components of the apparatus are connected in a “strictly” serial fashion having only one inlet and one outlet (indeed, one or more additional waste outlets may be included). However, in preferred embodiments additional fluid in- or outlets may be arranged between or corresponding the individual process means. For example, in case very reactive fluids are used which would be harmful to specific components “further down”, these fluids may be let out at a higher level. Correspondingly, to avoid purging components already used, fluids may be introduced at a “lower” level.

The fluids may be supplied by means automatically and sequentially supplying a plurality of fluids or mixtures thereof in a timed fashion, or the fluids may be supplied fully manually, e.g. by connecting individual syringes containing the different fluids.

In preferred embodiments additional process, measuring or collecting means may be provided in serial fluid communication with the above-described process means, just as additional in- and outlets may be provided.

### BRIEF DESCRIPTION OF THE DRAWINGS

In the following the invention will be further described with references to the drawings, wherein

FIG. 1 shows a schematic representation of an embodiment of the invention,

FIG. 2 shows a fluid delivery module,

FIG. 3 shows a sample holder module,

FIGS. 4A and 4B show first and second embodiments of a heating module,

FIG. 5 shows a purification module,

FIG. 6 shows an exchange module,

FIGS. 7A and 7B show first and second embodiments of a collecting module.

FIG. 8 shows a flow-chart for purification process,

FIG. 9A shows a flow-chart for the set-up shown in FIG. 9B,

FIG. 9B shows a first embodiment for a process set-up,

FIG. 10A shows a flow-chart for the set-up shown in FIG. 10B,

FIG. 10B shows a second embodiment for a process set-up,

FIG. 11A shows a flow-chart for the set-up shown in FIG. 11A,

FIG. 11B shows a third embodiment for a process set-up,

FIGS. 12A and 12B show a fourth embodiment for a process set-up,

FIG. 13A shows a flow-chart for the set-up shown in FIGS. 12A and 12B, and

FIG. 13B shows a block-diagram representation of the fourth embodiment.

### DESCRIPTION OF THE PREFERRED EMBODIMENTS

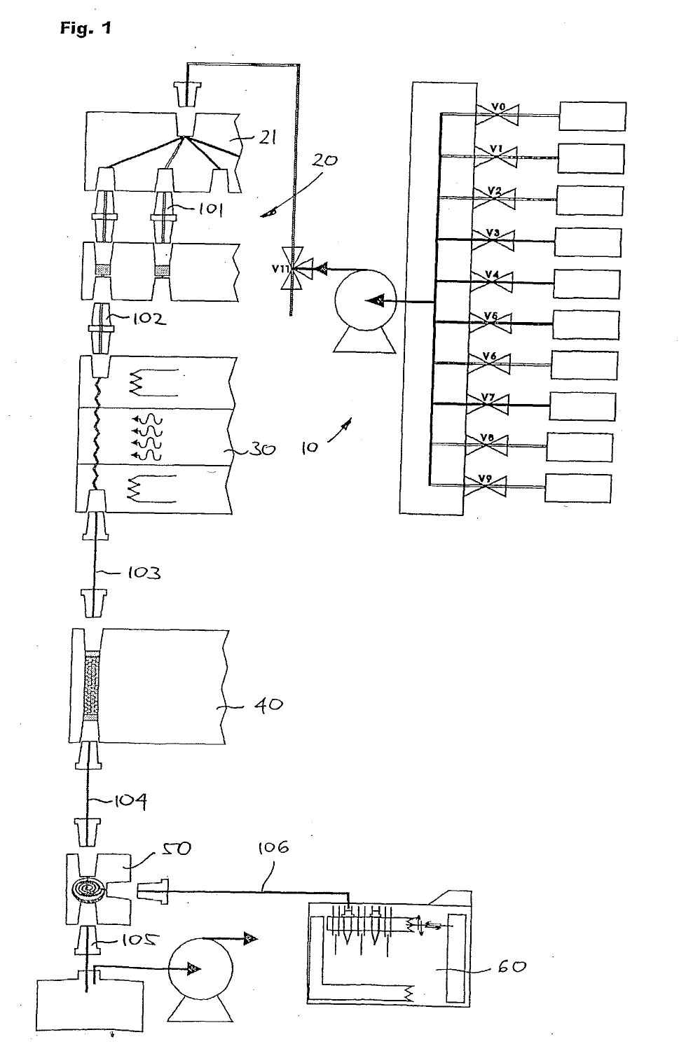

FIG. 1 shows a schematic representation of an embodiment of the invention in the form of an apparatus for automated, single or multi channel, energy assisted chemical reactions with subsequent purification and buffer exchange. The shown apparatus is build by connecting a number of individual modules, however, two or more modules may be integrated into a single unit. The modules are for illustrative purposes shown with flow connecting means in a non-assembled state.

More specifically, the apparatus comprises a fluid delivery module 10 (FM), sample holder module 20 (SM) including splitting device sub-module 21, heating module 30 (HM), purification module 40 (PM), exchange module 50 (EM) and collecting module 60 (CM), the modules/sub-modules-being serially connected by means of flow connectors 101-106. The apparatus further comprises control means for controlling the flow of fluids, actuation of valves, cooling/heating means etc. (not shown). In the following the individual modules will be described in greater detail. When the terms channel or conduit is used in the following this does not imply any specific configuration thereof, the conduit or channel merely defining a structure which may have any form (e.g. straight or curved) and any cross-sectional form (e.g. constant or varying).

The fluid delivery module (FM) as shown in FIG. 2 is adapted for delivering specified volumes of liquids or gasses at specified rates necessary for the different process steps. The fluids may be supplied either by applying a gas pressure, by means of a pump or by a combination thereof. In both cases, the gas/pump should be inert in respect of the fluids and materials used in the process. The shown delivery module comprises a plurality of fluid containing vessels 11 connected to a manifold 12, a pump 13 connected to the manifold and a purging device 14.

The manifold comprises a plurality of inlets 16 in fluid communication with the respective fluid containing vessels and a common outlet, the inlets being controlled by individual valves V0-V9. The common outlet is connected to an electronically controlled central pump 13 which is capable of delivering liquid and/or gas from each of the vessels to the following module. The purging means in the form of an electronically controlled valve means V11 is preferably arranged after the pump outlet to ensure the possibility of purging the fluids. In this case a first outlet 18 from the valve means is connected to a waste container (not shown) and a second outlet 19 is connected to the subsequent module. In the shown embodiment a three-way valve is used.

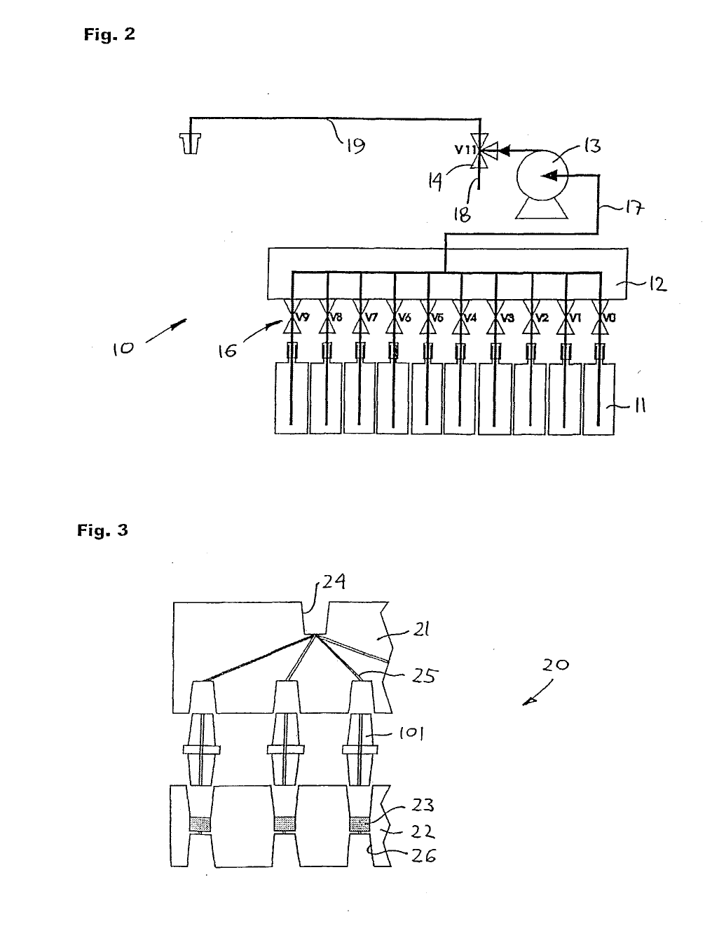

The sample holder module (SM) as shown in FIG. 3 is adapted to supply equal amounts of fluids to the individual samples of biological material and passing it on to the next module(s) as described below. The shown sample holder module comprises a top portion 21 including a manifold, a lower portion 22 comprising a plurality of channels each including sample holding chambers for holding a sample 23 and providing the transition to the following module, and connecting means 101 for establishing fluid communication between the individual outlets from the splitting device and the corresponding samples and for locking the two portions to each other.

Initially, chemically synthesized or naturally produced molecules will be attached by any means, or combination of means, to a solid support (the synthesis matrix), e.g. through chemical bond attachment, affinity attachment, ion exchange attachment, filters or through size in- or exclusion attachment. The solid support may be in form of, for instance, particles (such as solid, porous, or hollow beads) permeable or impermeable membranes or filters, stable emulsified droplets, and solid support surfaces in any desired configuration.

The sample holder unit is adapted such that the attached molecules can be located in the unit and liberated from the solid support and transported to the next modules by incoming fluids. When this task has been fulfilled, fluids for other purposes will-be transported through the module. The module will, however, in these situations merely serve as tubing.

The number of channels that are present in the manifold provides the maximum number of process units that can be run simultaneously in a given set-up. Each channel belongs to a separate process unit in the sense that no fluid or solid material should be able to be transferred from one channel to another. Each channel should be capable of handling the specified fluids for the subsequent procedures, otherwise a shunt should be provided as described below. These requirements ensure that cross contamination between the channels will not take place.

In the following it will be assumed that the solid support, during the full time of operation of the set-up, is contained in a membrane (e.g. CPG-MemStar DNA Synthesis Columns (CPG Inc., NJ, U.S.A.)), that fulfills certain requirements, e.g. the membrane can be used in a standard oligodeoxynucleotide synthesizer. This requirement is, however, only illustrative for the following description. With small modifications of the top and lower portions or by insertion of an adapter between the top and the lower portion the system can be modified to accept other kind of sample carriers, e.g. synthesis columns as well as solid supports.

The top portion 21 in the form of a manifold block comprises a common inlet 24 connected to the outlet 19 of the three-way valve in the fluid delivery module, and a plurality of outlets 25 which correspond to the number of channels through the manifold. Each outlet is formed such that it can receive a connector 101 with a channel (or conduit) formed there through, e.g. a double male luer as shown. Each connector is capable of being inserted fluid tight into both the top and lower portion. The channel inside one connector leads directly from the channel in the top portion to the inlet of the corresponding sample holding chamber. That each channel in the top portion is connected to one hollow connector ensures that fluid supplied from a specified vessel in the fluid delivery module will be lead out through the tip of the connector and separately into each sample holder chamber.

The sample holding chambers are formed integrally with the lower portion and comprise inlets of suitable shape providing a fluid tight connection with the corresponding hollow connector, thereby ensuring that fluid is conducted to the individual samples 23 arranged in the sample holding chambers. The outlets 26 from the individual sample holding chambers are formed to ensure a fluid tight communication with a subsequent module, for example using a corresponding hollow connector.

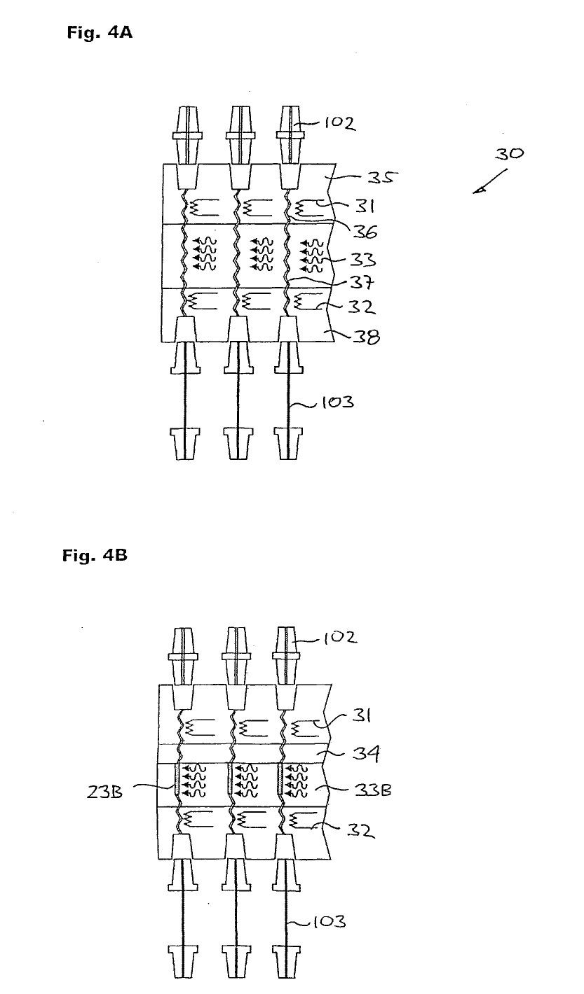

The heating module (HM) as shown in FIG. 4A is adapted to supply energy to fluids and compounds contained therein. In the shown example the module is capable of both heating and cooling the fluids in each of the channels from a previous (i.e. upstream) module and passing the fluids on to the next module or modules in a below-specified manner. The heating and cooling is controlled according to the process to be carried out. As will explained in greater detail below, the cooling is applied to provide a flow control means, however, this functionality may be provided by any desirable means such as traditional valves or pinch valves acting on flexible tubing.

Generally, the purpose of the heating is to accelerate the speed at which chemical reactions take place, e.g. removing protecting groups or other for the synthesis necessary or desirable groups, attached to the molecules contained in the initial sample. The heating should be sufficient to ensure that all desired chemical reactions have taken place before the reaction products are transferred from the module, e.g. full deprotection of the molecules.

FIG. 4B shows an embodiment in which the heating and cooling means are formed integrally with the sample holding means to form a combined module, whereby both full deliberation and deprotection of the molecules can be obtained in an efficient manner before they are passed on to the next module or modules in a specified and controlled manner, ensuring that fluids for other purposes can be transported through the combined module, the module thereby serving merely as tubing for transport of fluids for any subsequent serially connected module.

Heat may be applied by convection, conduction, IR irradiation or dielectric elements. In particular microwave irradiation may be applied. The following, description will be based on a module applying microwave-generated heating; the use of other heating techniques may require differently shaped devices. The module basically comprises at least one cooling applicator 31, 32 and a microwave applicator 33.

Before entering the microwave applicator the channel from the previous module passes through inlet cooling means 31. The cooling means may be in the form of a Peltier element.

From the cooling means the channel passes the microwave applicator 33 wherein the channel is irradiated with microwaves; correspondingly the channel wall at this location is made from a material that has a high penetration depth for microwaves. When the channel leaves the microwave applicator it is lead through an outlet cooling means 32 in a way similar to the one described above. The inlet and outlet cooling means may be provided as a single cooling device, or they may be separate means as shown in FIGS. 4A and 4B.

When heating is performed the fluid/compound mixture contained in the heating means would normally expand, however, the purpose of the cooling means is to control the flow of the fluid/compound mixture during heating; preferably the mixture is frozen but in some aspects the desired control may be achieved by merely increasing the viscosity of the mixture. Indeed, in order achieve this, the fluid/compound mixture has to comprise a sufficient amount of liquid. The length of the channel upon which cooling takes place is chosen according to the lumen of the channel as well as the pressures generated. The channel may typically be formed by a tube having a very small internal diameter, e.g. 0.5 mm, for which only a very short portion will have to be frozen in order to block flow. Due to the very steep thermal gradient between the cooling and heating zones, the frozen mixture will liquefy almost instantly when cooling is turned off.

Indeed, by controlling the flow in- and outlets from the heating location the pressure will rise; correspondingly the channels should be adapted to withstand such a pressure rise. After the final exit from the heating module the channel may be fitted with flow regulating means (e.g. a flow restrictor or back pressure tubing 103) to ensure that the fluid is lead to the next module under an appropriate control.

In the shown embodiment the heating module comprises a top portion 35 including the first cooling means 31 and a plurality of channels or conduits 36 being formed there through and each having an inlet, a microwave applicator 33 with a plurality of channels or conduits 37 being formed there through, and a lower portion 38 including the second cooling means 32 and a plurality of channels or conduits 39 being formed there through each having an outlet, the three components sealingly engaging each other to form a plurality of individual channels extending between the inlets respectively the outlets, each channel passing the first cooling means, the heating means and the second cooling means. However, in a further preferred embodiment, the different components may be formed integrally.

The embodiment of FIG. 4B differs from the embodiment of FIG. 4A in that a sample holder chamber 23B is formed integrally with a microwave applicator 33B, just as means 34 is provided to allow access to the chambers.

The in- and outlets are connected to the neighboring modules or equipment by means of hollow connectors 102, 103 as described above.

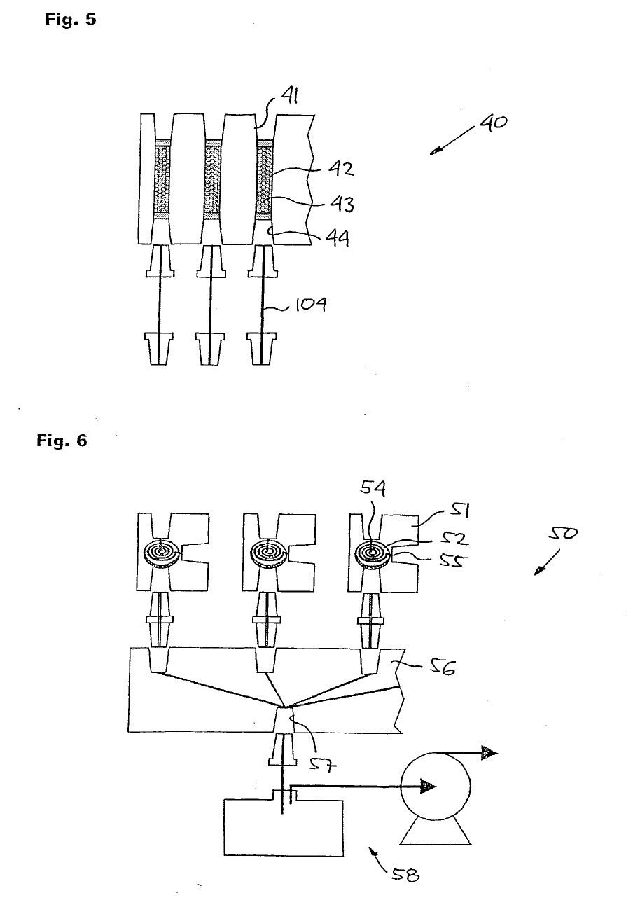

The purification module (PM) as shown in FIG. 5 is in the form of a column adapted to separate, by use of a mobile and a stationary phase, the different molecules released from the matrix in the sample holder module and, if provided, deprotected in the heating module.

The purpose of the module is to separate undesirable molecules (e.g. protecting groups, non-full length molecules etc.) from desirable molecules (e.g. full length synthesis products) and when this purpose is fulfilled ensure that the desirable molecules can, if wanted, be passed on to the next module or modules in a specified and controlled manner, and ensure that fluids for other purposes can be transported through the module. The module will in this subsequent situation merely serve as tubing.

In order to fulfill the above mentioned purpose, all or part of the chemically synthesized or naturally produced molecules should be withhold initially in the stationary phase, e.g. by means of diffusion, dipole-dipole interaction, hydrogen bindings interaction, physically retention etc. or combinations thereof, this before the mobile phase (i.e. the fluids supplied through the module) interacts with the molecules and carries them through the module in a desired order, e.g. according to size, charge, hydrophobicity, hydrophilicity or weight.

Among the techniques which may be useful for achieving the above mentioned influence on the produced molecules are: reversed phase chromatography, affinity chromatography, ion exchange chromatography, gas chromatography, capillary electrophoresis, size exclusion chromatography and combinations thereof. The stationary phase may be in form of particles (such as solid, porous, or hollow beads) permeable or impermeable surfaces, membranes or filters, or stable emulsified droplets in any desired configuration. For simplicity the below description refers to a single channel in the module. Preferably, the purification module is adapted to fully bind all molecules carried thereto by the incoming fluid.

The shown module comprises transition means for connecting to a previous module, purification chambers 42 containing the binding means 43 (matrix) for binding the molecules in the stationary phase, and transition means 44 to a following module. The different portions are formed integrally with each other providing a plurality of channels, each channel comprising a binding means as well as in- and outlets allowing all fluid supplied to a given channel to be directed through the binding means.

The in- and outlets may be connected to the neighboring modules or equipment by means of hollow connectors 103, 104 as described above. If desired, the latter may comprise flow restriction means capable of minimizing the difference in pressure (if any) created in the purification columns due to differences in the selected purification matrix.

The exchange module (EM) as shown in FIG. 6 is adapted for performing buffer exchange in order to transfer the purified product to a suitable buffer needed for further use and ensure that a pass on to the next module or modules, if desired, is possible, and so ensure that fluids for other purposes can be transported through the module, which then will merely serve as tubing.

Generally, a buffer exchange may be archived by either moving the product molecules to the desired buffer or by replacing fully or partly the undesirable buffer with the desirable or a combination thereof.

Among the techniques which might be used for archiving the above object are: electro elution, electro dialysis, electro filtration, (vacuum) membrane filtration, evaporation membrane filtration, cutoff filtration, affinity filtration, size filtration and combinations thereof. In the following a module for performing vacuum membrane filtration will be described.

The shown exchange module comprises a top portion 51 including a plurality of planar coiled hollows 52 (each forming a spiral) formed on a lower surface thereof and adapted to engage a filter membrane 53, the hollow having an inlet end 54 and an outlet end 55, the inlet being in fluid communication with a transition means for connecting with a previous module, the outlet being in fluid communication with a further transition means for connecting with a subsequent module; a lower portion 56 comprising a chamber housing a cutoff filter 53 and a transition 57 to a vacuum system 58. The vacuum system acts on the filter to draw fluid there through from the coiled hollow and includes waste collecting means for the exhausted fluids. The two portions are in sealing engagement with each other.

When the coiled hollow is placed in engagement with the filter membrane, a “closed” channel is formed, the channel being “open” towards the cutoff filter along its entire length, thereby permitting the fluid carrying the purified sample to come under influence of the vacuum system. As the purified sample (ideally) is prevented from being drawn through the pores of the membrane, the fluid initially carrying the purified product will be exchanged by the exchange-fluid subsequently supplied to the module. As appears, the exchange module has two outlets, i.e. the vacuum (waste) outlet 57 and the-outlet 55 in communication with the hollow. Depending on the pressures applied, all or none of the supplied fluid will be drawn through the filter. Therefore, in order to properly distribute the purified sample along the length of the hollow, both pressures are preferably controlled, the vacuum by regulating the vacuum pump, the outlet pressure by providing a throttle means adjustable from fully open to fully closed; such a throttle means may be provided as a pressure regulation module (PRM). Indeed, the settings of the controls will depend, among other parameters, upon the filter characteristics and the nature of the sample.

The in- and outlets may be connected to the neighboring modules or equipment by means of hollow connectors 104, 105, 106 as described above.

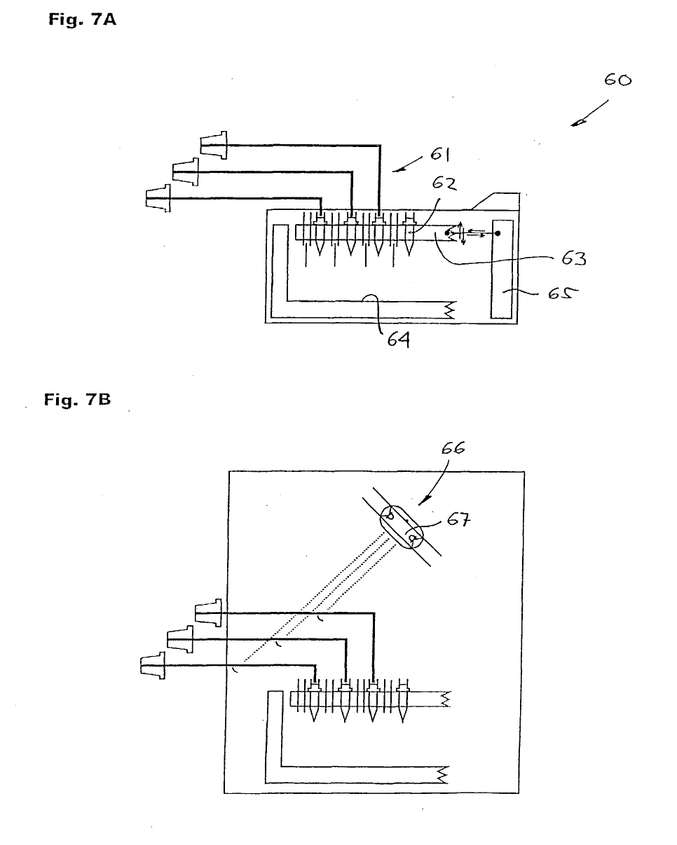

The collecting module (CM) as shown in FIG. 7A is adapted for collecting the desirable product(s) from one or more samples in a specified and controlled manner and ensure that fluids used for other purposes will be transported to one or more containers separated from the product collecting unit.

In order to meet these requirements either the tube or tubes in which the sample-containing fluid flow may be moved to a position enabling collection in a specified collecting vessel or the specified collecting vessel may be moved in position relative to the tube outlets, or a combination thereof. The collecting means may be provided with measuring means for measuring one or more characteristics of the purified samples, e.g. by using online UV-, pH- or Ion-measuring means. Indeed, such measuring means may be applied throughout the set-up at any desirable location.

For simplicity the below description refers to a collection unit being movable relative to the tube outlets, the movements being electronically controlled The collecting module comprises a connecting unit 61 including the fluid communication means 106 for a previous module, a plurality of collecting vessels 62 mounted in a carrier 63 and placed over a waste receptacle 64, and an electronically controlled mechanical means 65 for moving the carrier and thereby the collecting vessels relative to the outlets from the previous module.

The connecting unit 61 comprises a plurality of inlets in the form of hollow connectors corresponding to the number of channels, whereby individual outlets from a previous module 50 can be connected in fluid communication therewith and the fluid conducted to individual outlets situated above the collecting vessels.

In this way a product deliberated in the sample holder module, deprotected in the heating module, purified in purifying module, buffer exchanged in the exchange module, is thereby carried to the outlet situated above (or partly immersed in case the carrier can be moved up and down) in the adjoining collecting module and collected in the individual vessels, by a mobile phase originating from the fluid delivery module. During the processing of samples, waste fluids will be produced which may be directed through waste channels in the appropriately positioned carrier.

Preferably, the collecting module comprises a sufficient large waste container 64 to contain all waste fluids produced during processing, the collecting vessels containing the desired fractions of the processed samples.

In FIG. 7B a measuring module 66 (MM) for measuring the concentration of one or more products from one or more samples for the individual collecting vessels is provided. The purpose is to determine the concentration of the collected product or products in the individual vessels. The shown measuring module comprises a UV emitter and detector 67 in order to obtain online light-absorption measurements.

In the following examples illustrating different aspects of the invention, the above-described modules are used in different combinations; however, additional features will also be described. The different set-ups are may be in the form of either multi-channel or single-channel set-ups.

### EXAMPLE 1

A multi-channel set-up is provided substantially as shown in FIG. 1, the individual modules being serially connected to each in order to provide a plurality of individual uni-directional process channels starting from the inlet to the sample holding chamber and terminating at the corresponding outlet from the exchange module, such a set-up being suitable for “general-purpose” purification of synthesis-products.

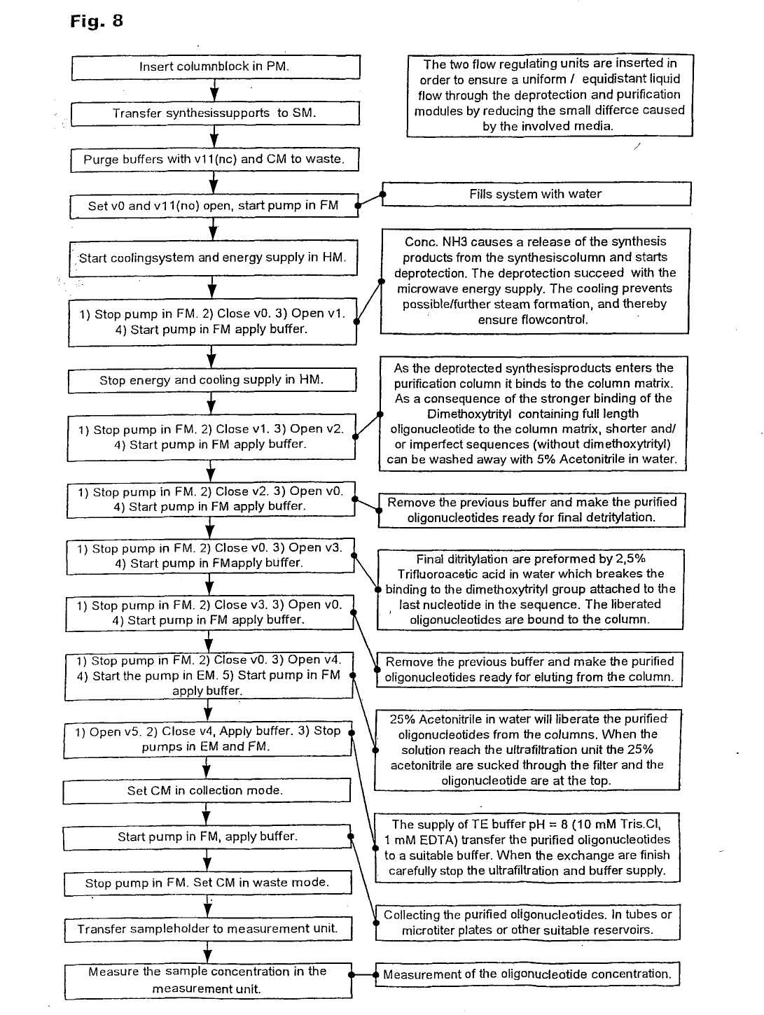

The purification process is performed as described in the flow-chart shown in FIG. 8 with the process steps in the left column and comments in the right column.

### EXAMPLE 2

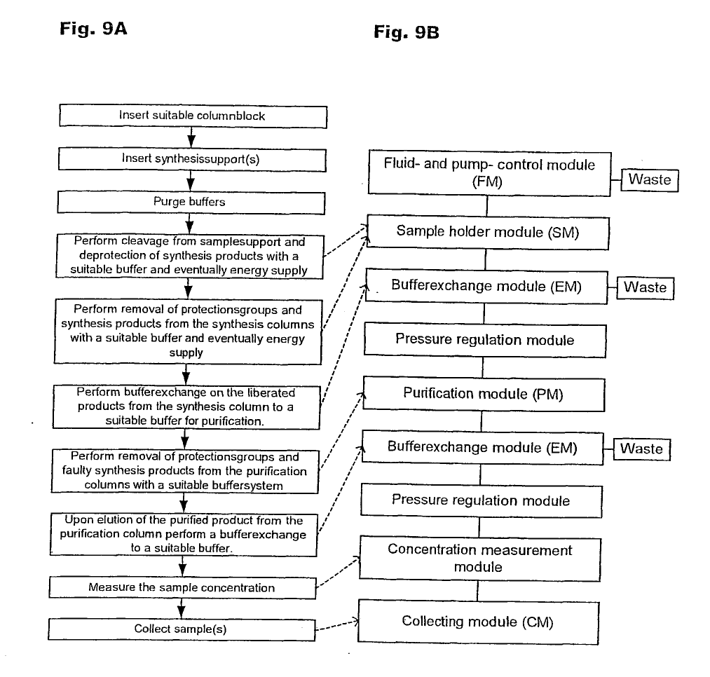

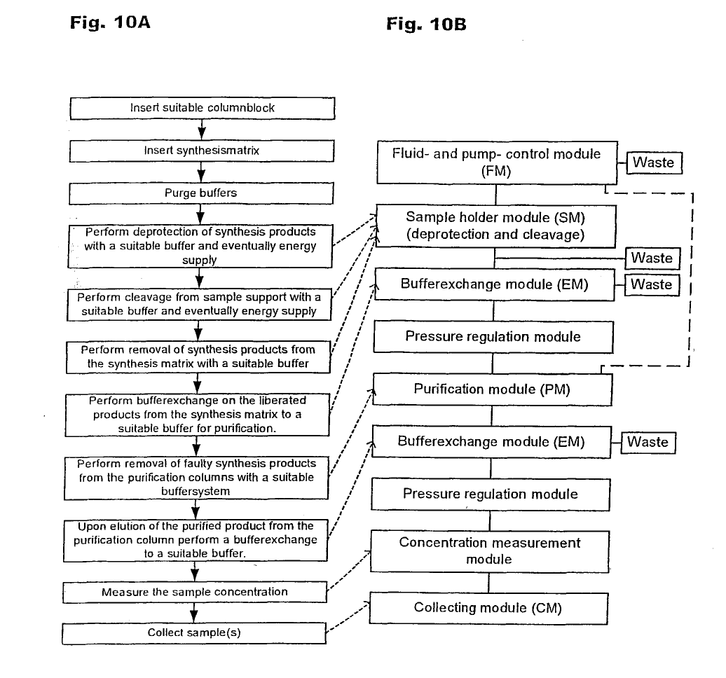

A multi-channel set-up as shown schematically in FIG. 9B is provided generally corresponding to the set-up used in example 1, with the following differences: The sample holder module is provided with heating means corresponding to the FIG. 4B embodiment, buffer exchange modules are arranged after both the sample/heating module and the purification module, and pressure regulation modules are provided in combination with each of the buffer exchange modules. The shown set-up is suitable for purification of peptide synthesis-products.

The purification process is performed as described in the flow-chart shown in FIG. 9A.

### EXAMPLE 3

A multi-channel set-up as shown schematically in FIG. 10B is provided generally corresponding to the set-up used in example 2, with the following differences: The sample/heating module is used in a two-step process with deprotection and cleavage performed separately, however, as some of the fluids used for these processes are very reactive and thus harmful for some of the subsequent components (e.g. purification and filter elements), an additional controllable waste outlet is provided in front of the first buffer exchange module. In addition, in order to bypass the sample holder module an additional supply conduit (shown in broken line) may be provided between, for example, the fluid supply means and the purification module; evidently, this does not influence the strictly serial set-up for the sample process-channels. The shown set-up is suitable for purification of peptide synthesis-products.

The purification process is performed as described in the flow-chart shown in FIG. 10A.

### EXAMPLE 4

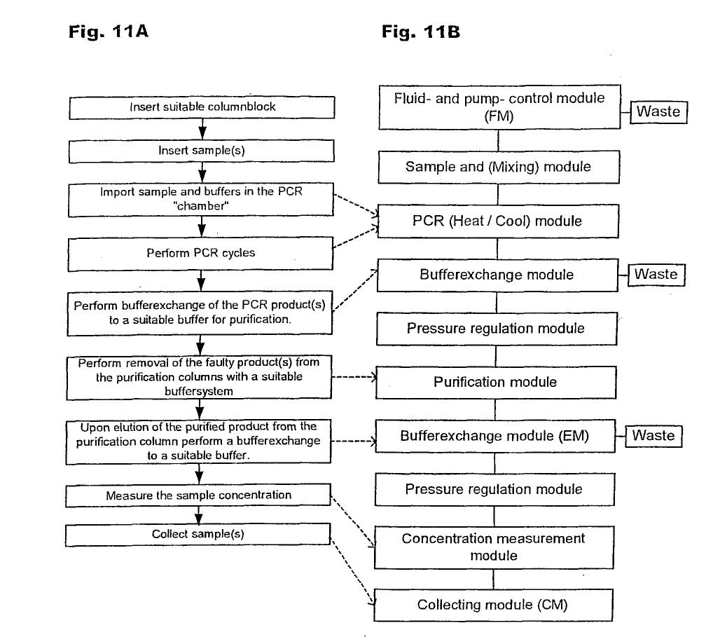

A multi-channel set-up as shown schematically in FIG. 11B is provided generally corresponding to the set-up used in example 2, with the following differences: The sample holder module is adapted to serve as a mixing module in which the sample to be processed is introduced together with the specified reagents before being transferred to the heating module serving as a reaction chamber for a PCR (polymerase chain reaction) process.

The shown set-up is suitable for a PCR-based DNA synthesis process performed as described in the flow-chart shown in FIG. 11A. In a similar PCR-based DNA synthesis process (not shown) purification may take place using capillary electrophoresis, just as one or both exchange modules may be dispensed with.

In the above examples several modules have been connected serially, however, according to the invention, a set-up may comprise only two modules arranged in serial connection with a sample holder and associated fluid supply means. In case flow control means is provided on a heating module, the set-up in accordance with the invention may comprise a heating module serially connected with a sample holder or an additional process module. In both aspects processes which have hitherto been performed in a laborious step-by-step fashion can now be performed serially in a “closed” system, allowing both improved efficiency, reduced costs as well as minimizing the risks for contamination of the samples and sample products.

In the shown examples several individual modules have been connected to provide an aggregate process set-up, however, two or more modules, or components thereof, may be incorporated into a single unit which may be for disposable use. For example, a disposable unit may be provided comprising a “full” conduit comprising one or more disposable components such as filters or columns, the unit being provided with the necessary in- and outlets to be connected with the durable equipment, e.g. fluid supplying means, vacuum means, heating/cooling means, valve actuation means, measuring means and collecting means.

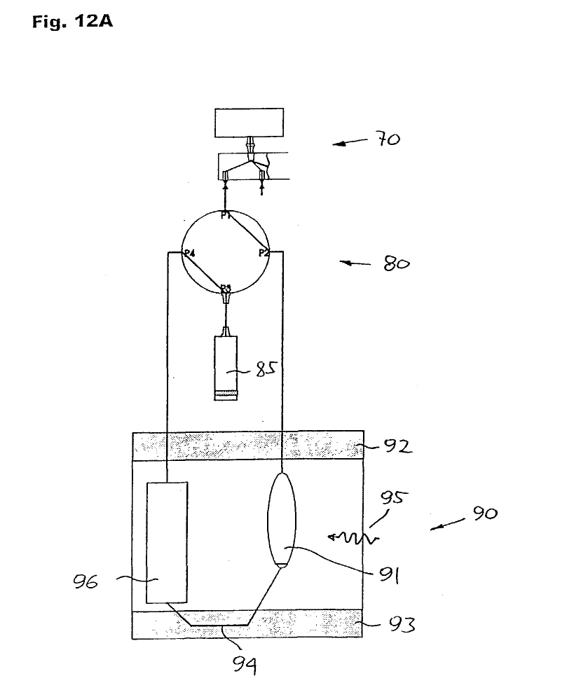

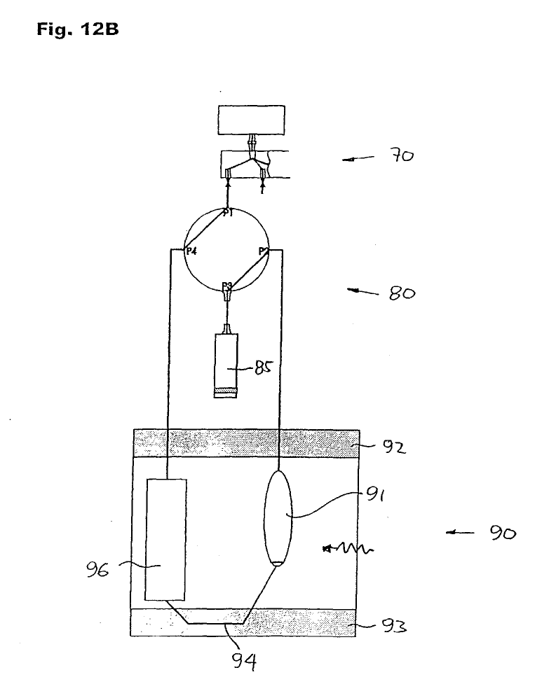

With reference to FIGS. 12A and 12B a further aspect of the invention providing an apparatus for automated, single or multi channel, energy assisted chemical reactions of a sample material with subsequent energy assisted chemical reactions for detection of a specified organic molecule. For illustrative purposes, only a single channel is shown.

In the shown embodiment the apparatus comprises three modules. A first module is in the form of a fluid delivery module 70, for example as shown in FIG. 2, adapted for delivering specified volumes of fluids at specified rates necessary for the different process steps.

The second module is in the form of a valve 80 for directing fluids supplied from the fluid delivery module to one of the units or chambers in the preparation and detecting module (to be described below), as well as for directing fluids from the units to a sample or waste collecting receptacle 85.

The third module 90 comprises two chambers each having in- and outlets (which may serve as the reverse). The first chamber is in the form of a mixing chamber 91 to which the sample and one or more reactants are supplied from the fluid delivery means. If the sample treatment involves heating 95 (heat supplying means not shown) the in- and outlets are provided with flow control means 92, 93 which may be in the form of cooling/freezing means as described above. After treatment in the mixing chamber the processed sample or a part thereof is transferred to a detection chamber 96 via fluid communication means 94 by supplying “transport” fluid from the fluid delivery means. Any excess fluid will be directed through the valve 80 to the waste receptacle.

The detection chamber comprises reagents for specifically binding components from the sample to be detected. In the detection procedure (such as in ELISA) the bound components are treated with a number of reactants in order to produce a detectable marker. In order to avoid supplying these reactants through the mixing chamber, the valve may be reversed as shown in FIG. 12B. Any excess fluid supplied to the detection chamber will be directed through the mixing chamber via the valve to the waste receptacle.

If the detection procedures involve heating (e.g. in the form of energy radiation 95) the in- and outlets may be provided with flow control means which in the shown embodiment is in the form of the same cooling/freezing means as described above.

In the above example, fluids are supplied by pumping, however, suction may also be applied to direct the fluids, just as pulsing application of pumping/suction pressures may by used to mix fluids and/or sample components in the chambers. Further, the two chambers may be formed as individual components or they may be formed integrally with the valve and/or the waste receptacle.

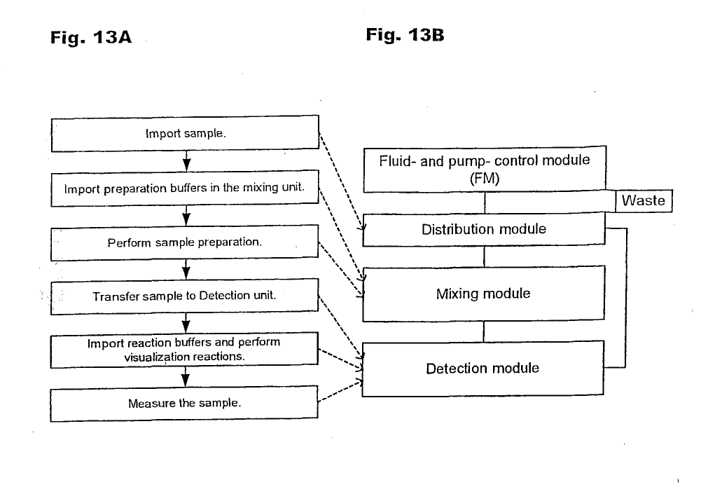

The single-channel set-up as shown in FIGS. 12A and 12B is schematically represented in FIG. 13B, the detection procedure being performed as described in the flow-chart shown in FIG. 13A.

For the above system, the fluid supply, energy supply, flow control and/or valve control may be manually or electronically controlled, just as a plurality of units may be arranged in a single module. To mention a very specific application, the shown embodiment would be suitable for the detection of the mecA gene in methicillin-resistant Staphylococus aureus and simultaneously differentiate between Staphylococus aureus and non-Staphylococus aureus by detection of the nuc gene.

1. A method for processing organic material said material being biopolymer containing products and/or biological samples, comprising the steps of:
providing fluid supplying means (10) having an outlet,
providing receiving means (20) comprising a conduit having an inlet and an outlet, the conduit being adapted for receiving a sample of organic material,
providing first and second process means (30, 40) each comprising a conduit having an inlet and an outlet, the conduit comprising, or having associated therewith, a process means for processing a sample of organic material,
placing organic material (23) in the receiving means,
establishing, if not already provided, fluid communication (19) between the outlet of the fluid supplying means and the inlet of the receiving means, and fluid communication (102, 103) between the receiving means and the first and second process means by serially connecting corresponding in- and outlets in fluid communication with each other, thereby establishing at least one conduit through which fluids can be supplied from the fluid supplying means through the receiving means and the first and second process means,
conducting at least one fluid through the serially connected conduits said method providing a linear continuous process.

2. A method as defined in claim 1, wherein said biopolymer is selected from polynucleotides and peptides.

3. A method as defined in claim 1, adapted for recovery of a biopolymer contained in a matrix, the matrix being placed in the receiving means, wherein
at least one of the process means is taken from the group comprising heat exchange means (30) comprising heating means (33), purification means (40) comprising means for reversibly binding a biopolymer in a stationary phase, and solvent exchange means (50).

4. A method as defined in claim 3 wherein a solution is passed from the fluid supply means, to the receiving means, releasing the biopolymer from the matrix, transferring the biopolymer to a heat exchange means, and releasing one or more protection groups from the biopolymer.

5. A method as defined in claim 1 comprising controlling flow by flow control means acting on the in- and outlets of a heat exchange means.

6. A method as defined in claim 5 wherein the flow-control is obtained by a cooling/freezing function.

7. A method as defined in claim 1, adapted for synthesis of a biopolymer, the organic material being initially placed in the receiving means, wherein
one of the process means is adapted for supplying heat and comprises flow control means (31, 32) acting on the in- and outlets thereof.

8. A method as defined in claim 7 wherein the flow-control is obtained by a cooling/freezing function.

9. A method as defined in claim 7 wherein said method is a polymerase chain reaction (PCR).

10. A method as defined in claim 9 wherein the organic material initially placed in the receiving means comprises specified reagents or reactants required in a PCR reaction.

11. A method as defined in claim 7 wherein a biological sample and specified reagents for a PCR reaction are introduced to the receiving means, the sample and reagents are mixed, and together they are transferred to heat exchange means where a heating/cooling process is performed.

12. A method as defined in claim 11 further processing the biological sample in a process means, said process means comprising solvent exchange means and purification means.

13. A method as defined in any one of claims 1, 3, 7 or 11 further comprising detecting the biopolymer in detection means.

14. A method as defined in claim 13, wherein the concentration of the biopolymer is measured in the detection means.

15. A method as defined in claim 13 wherein the biopolymer is a peptide and the detection is in the form of enzyme-linked immunosorbent assay (ELISA).

16. A method as defined in claim 3 or 7 wherein said heat exchange means comprises microwave applying means.

17. A method as defined in claim 1 wherein one or more methods can be performed in parallel.

18. An apparatus for processing organic material said material being biopolymer containing products and/or biological samples, comprising:
fluid supplying means (10) having an outlet,
receiving means (20) comprising a conduit having an inlet and an outlet, the conduit being adapted for receiving a sample of organic material,
first and second process means (30, 40) each comprising a conduit having an inlet and an outlet, the conduit comprising, or having associated therewith, a process means for processing a sample of organic material,
a fluid communication (19) between the outlet of the fluid supplying means and the inlet of the receiving means, and serial fluid communication (102, 103) between the receiving means and the first and second process means, the corresponding in- and outlets being in fluid communication with each other, thereby establishing at least one conduit through which fluids can be supplied from the fluid supplying means through the receiving means and the first and second process means,
the fluid supplying means preferably being adapted for sequentially supplying a plurality of fluids or mixtures thereof.

19. An apparatus as defined in claim 18, adapted for recovery of a biopolymer contained in a matrix being placed in the receiving means, wherein
at least one of the process means is taken from the group comprising heat exchange means comprising heating means, purification means comprising means for reversibly binding an organic compound in a stationary phase, and solvent exchange means.

20. An apparatus as defined in claim 19 consisting of
fluid supply means (10) having an outlet,
receiving means (20) comprising a conduit having an inlet and an outlet, the conduit being adapted for receiving a sample of biopolymer,
a heat exchange means comprising a conduit having an inlet and an outlet,
optionally further process means for processing a sample of biopolymer.

21. An apparatus as defined in claim 18 comprising flow control means acting on the in- and outlets of the heat exchange means.

22. An apparatus as defined in claim 21 wherein the flow-control is obtained by a cooling/freezing function.

23. An apparatus as defined in claim 18, adapted for synthesis of a biopolymer the organic compound being initially placed in the receiving means, wherein
one of the process means is adapted for supplying heat and comprises flow control means acting on the in- and outlets thereof.

24. An apparatus as defined in claim 23 wherein flow-control is obtained by a cooling/freezing function.

25. An apparatus as defined in claim 23 comprising
a receiving means for introducing and mixing a sample and specified reagents for a PCR reaction, with an inlet and an outlet, and
a heat exchange means for heating/cooling the mixture

26. An apparatus as defined in claim 20 or 23 further comprising purification means.

27. An apparatus as defined in claim 20 or 23 further comprising solvent exchange means.

28. An apparatus as defined in claim 18, 19, 23 or 25 further comprising detection means for detecting the biopolymer.

29. An apparatus as defined in claim 19 or 23 wherein said heat exchange means comprises microwave applying means.

30. An apparatus as defined in claim 18 wherein one or more conduits can be positioned in parallel.

31. A method for processing organic material said material being biopolymer containing products and/or biological samples, comprising the steps of:
providing fluid supplying means (10) having an outlet,
providing receiving means (20) comprising a conduit having an inlet and an outlet, the conduit being adapted for receiving a sample of organic material,
providing at least one process means comprising a conduit having an inlet and an outlet, the conduit comprising, or having associated therewith, a process means for processing a sample of organic material, wherein at least one of the receiving or process means comprises heating means (33, 33B) adapted for supplying heat to the conduit and comprises flow control means (31, 32) acting on the in- and outlets thereof,
placing organic material in the receiving means,
establishing, if not already provided, fluid communication between the outlet of the fluid supplying means and the inlet of the receiving means, and fluid communication between the receiving means and the process means by serially connecting corresponding in- and outlets in fluid communication with each other, thereby establishing at least one conduit through which fluids can be supplied from the fluid supplying means through the receiving means and the process means,
conducting at least one fluid through the serially connected conduits, and
supplying heat from the heat supplying means in combination with actuation of the flow control means said method providing a linear continuous process.

32. A method as defined in claim 31, wherein said biopolymer is selected from polynucleotides and peptides.

33. A method as defined in claim 31, wherein the heat supplying means is provided in combination with the receiving means, the process means is taken from the group comprising purification means comprising means for reversibly binding a biopolymer in a stationary phase, and solvent exchange means.

34. A method as defined in claim 31 adapted for recovery of a biopolymer contained in a matrix, the matrix being placed in the receiving means.

35. A method as defined in claim 34 wherein a solution is passed from the fluid supply means, through the receiving means provided in combination with a heat exchange means, releasing the biopolymer from the matrix, transferring the biopolymer via a conduit to a heat exchange means, and releasing one or more protection groups from the biopolymer.

36. A method as defined in claim 31 comprising controlling flow by flow control means acting on the in- and outlets of the heat exchange means.

37. A method as defined in claim 36 wherein the flow-control is obtained by a cooling/freezing function.

38. A method as defined in claim 31, adapted for synthesis of a biopolymer, the organic material being initially placed in the receiving means, wherein
one of the process means is adapted for supplying heat and comprises flow control means (31, 32) acting on the in- and outlets thereof.

39. A method as defined of claim 38 wherein flow-control is obtained by a cooling/freezing function.

40. A method as defined in claim 38 wherein said method is a polymerase chain reaction (PCR).

41. A method as defined in claim 40 wherein the organic material initially placed in the receiving means comprises specified reagents or reactants required in a PCR reaction.

42. A method as defined in claim 38 wherein a biological sample and specified reagents for a PCR reaction are introduced to the receiving means in combination with a heat exchange means, the sample and reagents are mixed, and together they are transferred to heat exchange means where a heating/cooling process is performed.

43. A method as defined in claim 42 further processing the biological sample in a process means, said process means comprising solvent exchange means and purification means.

44. A method as defined in claim 31, 34 38 or 42 further comprising detecting the biopolymer in detection means.

45. A method as defined in claim 44, wherein the concentration of the biopolymer is measured in the detection means.

46. A method as defined in claim 44 wherein the biopolymer is a peptide and the detection is in the form of enzyme-linked immunosorbent assay (ELISA).

47. A method as defined in claim 31, 35 or 38 wherein said heat exchange means comprises microwave providing means.

48. A method as defined in claim 31 wherein one or more methods can be performed in parallel.

49. An apparatus for processing organic material said material being biopolymer containing products and/or biological samples, comprising:
fluid supplying means (10, 70) having an outlet,
receiving means (20, 91) comprising a conduit having an inlet and an outlet, the conduit being adapted for receiving a sample of organic material,
at least one process means (20, 96) comprising a conduit having an inlet and an outlet, the conduit comprising, or having associated therewith, a process means for processing a sample of organic material, wherein at least one of the receiving or process means comprises heating means (33, 33B) adapted for supplying heat to the conduit and comprises flow control means (31, 32; 92, 93) acting on the in- and outlets thereof,
a fluid communication between the outlet of the fluid supplying means and the inlet of the receiving-means, and serial fluid communication (102, 94) between the receiving means and the process means, the corresponding in- and outlets being in fluid communication with each other, thereby establishing at least one conduit through which fluids can be supplied from the fluid supplying means through the receiving means and the process means,
the fluid supplying means preferably being adapted for sequentially supplying a plurality of fluids or mixtures thereof.

50. An apparatus as defined in claim 49, wherein the heat supplying means (33B) is provided in combination with the receiving means (23B), the process means is taken from the group comprising purification means comprising means for reversibly binding a biopolymer in a stationary phase, and solvent exchange means.

51. An apparatus as defined in claim 49, adapted for recovery of a biopolymer contained in a matrix being placed in the receiving means.

52. An apparatus as defined in claim 51 consisting of
fluid supply means (10) having an outlet,
receiving means (20) comprising a conduit having an inlet and an outlet, the conduit being adapted for receiving a sample of biopolymer,
a heat exchange means comprising a conduit having an inlet and an outlet, the conduit optionally comprising, or having associated therewith,
optionally further process means for processing a sample of biopolymer,

53. An apparatus as defined in claim 49 comprising flow control means acting on the in- and outlets of the heat exchange means.

54. An apparatus as defined in claim 53 wherein the flow-control is obtained by a cooling/freezing function.

55. An apparatus as defined in claim 49, adapted for synthesis of a biopolymer the organic compound being initially placed in the receiving means, wherein
one of the process means is adapted for supplying heat and comprises flow control means acting on the in- and outlets thereof.

56. An apparatus as defined in claim 55 wherein flow-control is obtained by a cooling/freezing function.

57. An apparatus as defined in claim 55 comprising
a receiving means for introducing and mixing a sample and specified reagents for a PCR reaction, with an inlet and an outlet, and
a heat exchange means for heating/cooling the mixture

58. An apparatus as defined in claim 55 further comprising purification means.

59. An apparatus as defined in claim 55 further comprising solvent exchange means.

60. An apparatus as defined in claim 49, 51, 55 or 57 further comprising detection means for detecting the biopolymer.

61. A method as defined in claim 49, 51 or 55 wherein said heat exchange means comprises microwave providing means.

62. An apparatus as defined in claim 49 wherein one or more conduits can be positioned in parallel.
